(19) United States
(12) Patent Application Publication
(10) Pub. No.: US 2026/0331359 A1
(43) Pub. Date: Oct. 22, 2026

(54) DUCT-TYPE AIR GUIDE AND MOLD TRANSFORMER FOR SHAFT GENERATOR OF VESSEL INCLUDING SAME

(71) Applicant: HD HYUNDAI ELECTRIC CO., LTD., Seongnam-si (KR)

(72) Inventors: Jong Gun Lee, Seoul (KR); Jong Hyung Woo, Seoul (KR)

(73) Assignee: HD HYUNDAI ELECTRIC CO., LTD., Seongnam-si (KR)

(21) Appl. No.: 19/463,131

(22) Filed: Jan. 29, 2026

(30) Foreign Application Priority Data
Apr. 1, 2025 (KR) 10-2025-0041900

(51) Int. Cl. H01F 27/28; H01F 27/02; H01F 27/08

(52) U.S. Cl. CPC H01F 27/2876; H01F 27/025; H01F 27/085

(57) ABSTRACT

A duct-type air guide for guiding cooling air to a winding portion of a mold transformer for a shaft generator of a vessel, includes a duct-shaped main body having an open lower portion, a suction port formed in a first end of the main body and configured to introduce external cooling air thereinto, and a winding portion cooling hole formed in an upper portion of the main body and configured to guide the cooling air to the winding portion of the mold transformer. The main body is formed of a plurality of divided plate members such that the main body is capable of being assembled.

### CROSS REFERENCE TO RELATED APPLICATION

The present application claims priority to Korean Patent Application No. 10-2025-0041900 (filed on Apr. 1, 2025), which is hereby incorporated by reference in its entirety.

### BACKGROUND

The present disclosure relates to a duct-type air guide and a mold transformer for a shaft generator of a vessel including the duct-type air guide. More particularly, the present disclosure relates to a duct-type air guide and a mold transformer for a shaft generator of a vessel including the duct-type air guide configured such that air leakage is suppressed in regions other than a winding portion so that a flow velocity of air rising toward the winding portion is increased, the duct-type air guide being capable of adjusting a flow velocity of air flowing through the winding portion, and the duct-type air guide having a simple design that does not require consideration of hole machining.

In a vessel, a system for generating electric power through a shaft generator interlocked with a propulsion shaft of an engine is widely used. The shaft generator is capable of continuously generating electric power while a main engine of the vessel is operated, thereby reducing fuel consumption and minimizing use of an auxiliary generator. Accordingly, in recent years, a shaft generator system has attracted attention as an alternative for increasing fuel efficiency and reducing greenhouse gas emissions, and reliability and efficiency of power equipment applied thereto have also become important.

In order to supply electric power generated by the shaft generator to an electric power system of the vessel after voltage transformation, a mold transformer is used. The mold transformer has a structure in which a winding is sealed with a solid insulating material, and thus insulation reliability may be secured even in a high-humidity environment such as a marine environment, so that the mold transformer is suitable for an electric power system for a vessel. Particularly, in a vessel environment in which maintenance is limited, adoption of a mold transformer having excellent mechanical strength and environmental resistance is common.

Performance and lifespan of the mold transformer are greatly affected by cooling efficiency. When heat is concentrated in a winding portion, insulation performance deteriorates, power loss increases, and failure due to overheating may occur. Accordingly, a forced cooling system using air is applied, and a structure for efficiently guiding cooling air introduced from outside to the winding portion is required.

Conventionally, a method of mounting a plate-type air guide in a middle portion or a lower portion of an enclosure to guide air flow has been used. This structure requires machining of a plurality of holes in consideration of a winding shape and an arrangement of internal lead wires, so that there was a problem that cooling air leaks to regions other than the winding portion. In addition, since a fixing structure of the plate-type air guide is not simple, assembly and maintenance are difficult to be performed, and it is also difficult to adjust a flow velocity or a direction of cooling air.

In a mold transformer for a shaft generator of a vessel, long-time continuous operation is required, so that securing a cooling structure capable of stably controlling a temperature of the winding portion is essential. In addition, since limitations of an installation space in the vessel and difficulty of maintenance are required to be considered, a structure which is easy to assemble and which has increased cooling performance is required. On the basis of such a technical background, an objective of the present disclosure is to provide a duct-type air guide that increases cooling efficiency of a winding portion while having a simple structure and easy maintenance.

### SUMMARY

The present disclosure relates to a duct-type air guide applied to a mold transformer for a shaft generator of a vessel, and aims to solve various problems occurring in a conventional flat plate-type air guide structure.

First, the conventional flat plate-type air guide requires machining of a plurality of holes to avoid interference with a winding shape or an arrangement of internal lead wires, so that air leakage frequently occurs. The present disclosure provides a structure in which only a minimum opening required for a winding portion is formed, thereby minimizing leakage of cooling air and allowing air to be concentratedly introduced into the winding portion.

Second, the conventional structure has insufficient capability of controlling a flow of cooling air or adjusting a flow velocity of the cooling air, so that it is difficult to stably secure cooling efficiency. Accordingly, the present disclosure introduces a structure in which a distance between an end plate and a main body is capable of being adjusted, so that sealing of an internal flow path and air flow are capable of being actively controlled.

Third, since the conventional structure is manufactured as an integral plate member, assembly of the conventional structure is difficult, and partial replacement is difficult when the conventional structure is damaged. The present disclosure implements a structure in which the main body is capable of being assembled from a plurality of divided plate members, so that installation and maintenance of the structure are facilitated and flexible countermeasure in various environments are capable of being realized.

According to an aspect of the present disclosure, there is provided a duct-type air guide for guiding cooling air to a winding portion of a mold transformer for a shaft generator of a vessel, the duct-type air guide including: a duct-shaped main body having an open lower portion; a suction port formed in a first end of the main body and configured to introduce external cooling air thereinto; and a winding portion cooling hole formed in an upper portion of the main body and configured to guide the cooling air to the winding portion of the mold transformer, wherein the main body is formed of a plurality of divided plate members such that the main body is capable of being assembled.

The main body may be assembled to a lower surface of an enclosure of the mold transformer and may form a duct having a width narrower than that of the enclosure, thereby forming a passage through which the cooling air flows.

The suction port may have a cross-sectional area that increases toward an outside thereof.

The duct-type air guide according to the present disclosure may further include an end plate mounted on a second end of the main body and configured to adjust an air flow and sealing of an internal flow path, and the end plate may be configured such that an assembly distance between the end plate and the main body is capable of being adjusted.

The duct-type air guide according to the present disclosure may further include: a fixing clip formed on the end plate such that the fixing clip extends toward the main body; and a slot hole provided in a side wall of the main body and formed in a position corresponding to the fixing clip such that the slot hole extends for a predetermined length, wherein the fixing clip may be fastened and fixed at a desired position of the slot hole, thereby adjusting the assembly distance between the end plate and the main body.

The fixing clip may be fixed at the desired position by fastening a nut to a threaded portion which extends from a first side of the fixing clip and which passes through the slot hole.

According to another aspect of the present disclosure, there is provided a mold transformer for a shaft generator of a vessel, the mold transformer including: an enclosure forming a predetermined space therein; at least one winding portion mounted inside the enclosure; and a duct-type air guide mounted on a lower portion of the enclosure and configured to guide external cooling air to the winding portion, wherein the duct-type air guide is assembled to a lower surface of the enclosure and forms a duct having a width narrower than that of the enclosure, thereby forming a passage through which the cooling air flows.

The duct-type air guide may include: a duct-shaped main body having an open lower portion; a suction port formed in a first end of the main body and configured to introduce external cooling air thereinto; and a winding portion cooling hole formed in an upper portion of the main body and configured to guide the cooling air to the winding portion of the mold transformer.

The main body may be formed of a plurality of divided plate members such that the main body is capable of being assembled.

The suction port may have a cross-sectional area that increases toward an outside thereof.

The duct-type air guide may further include an end plate mounted on a second end of the main body and configured to adjust an air flow and sealing of an internal flow path, and the end plate may be configured such that an assembly distance between the end plate and the main body is capable of being adjusted.

The mold transformer according to the present disclosure may further include a cooling air supply portion provided on a first side of the enclosure and configured to supply the cooling air to the duct-type air guide.

According to embodiments of the present disclosure, the duct-type air guide is mounted on the lower portion of the enclosure and effectively guides external cooling air to the winding portion, so that cooling efficiency may be significantly increased. As air is guided to directly pass through the winding portion, an air flow velocity may be increased and a temperature rise of a winding may be suppressed.

In addition, since the main body is formed of the plurality of plate members such that the main body is capable of being assembled, the manufacturing process is simplified and flexible countermeasure according to an installation space is capable of being realized. Accordingly, manufacturability and maintainability of the mold transformer may be increased, and work efficiency in an actual vessel environment may also be increased.

Through the structure in which the position of the end plate is capable of being adjusted, a flow of cooling air and internal pressure may be finely controlled, so that uniform cooling of each winding portion is capable of being realized. As a result, thermal reliability and lifespan of the entire transformer are increased.

Furthermore, by reducing unnecessary hole machining, the design is simplified and air leakage is minimized, thereby achieving increased results in terms of energy efficiency. This may lead to energy savings and operating cost reduction of vessel power equipment.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating a mold transformer for a shaft generator of a vessel according to an embodiment of the present disclosure;

FIG. 2 is an image illustrating main components of the mold transformer for the shaft generator of the vessel according to an embodiment of the present disclosure;

FIG. 3 is a perspective view illustrating a duct-type air guide according to an embodiment of the present disclosure;

FIGS. 4A and 4B are configuration diagrams illustrating a component for a distance adjustment function of an end plate of the duct-type air guide according to an embodiment of the present disclosure;

FIGS. 5A and 5B are enlarged views illustrating the component for the distance adjustment function of the end plate of the duct-type air guide according to an embodiment of the present disclosure;

FIG. 6 is a side image illustrating a path through which cooling air flows in the mold transformer for the shaft generator of the vessel according to an embodiment of the present disclosure; and

FIG. 7 is an image illustrating the path through which cooling air flows in the mold transformer for the shaft generator of the vessel according to an embodiment of the present disclosure.

### DETAILED DESCRIPTION

Hereinafter, exemplary embodiments of the present disclosure will be described with reference to the accompanying drawings. However, the present disclosure is not limited to the embodiments described herein and may be embodied in other forms. Rather, the embodiments introduced herein are provided so that disclosed contents will be thorough and complete, and will fully convey the scope of the present disclosure to those skilled in the art. Like components will be denoted by like reference numerals throughout the specification.

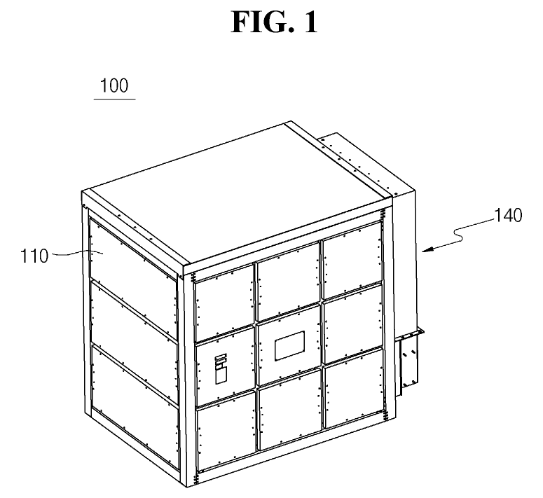

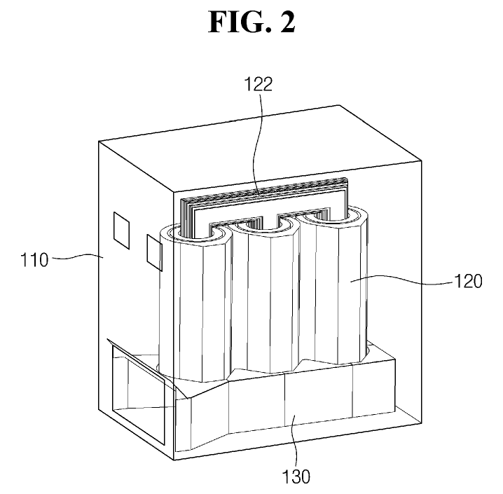

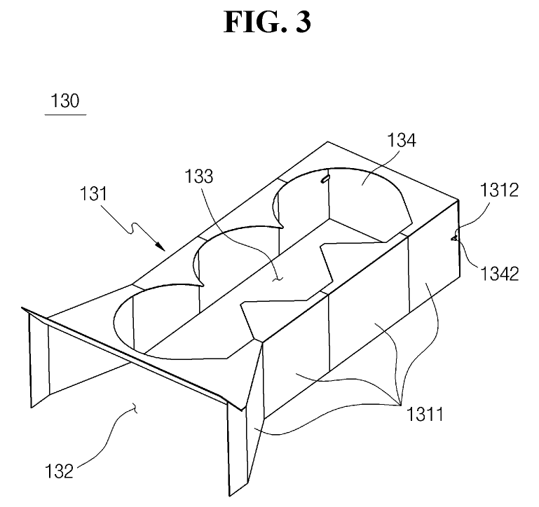

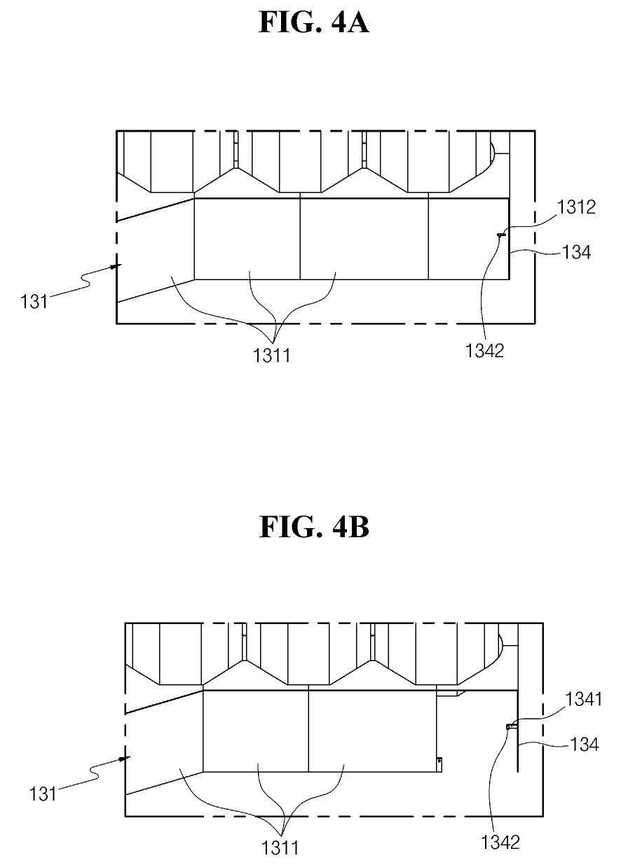

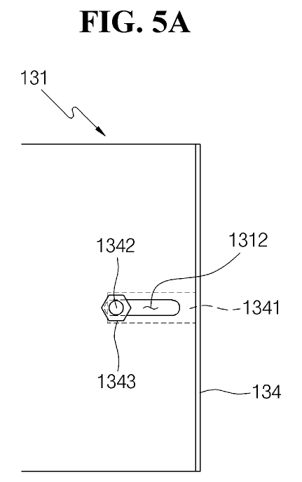

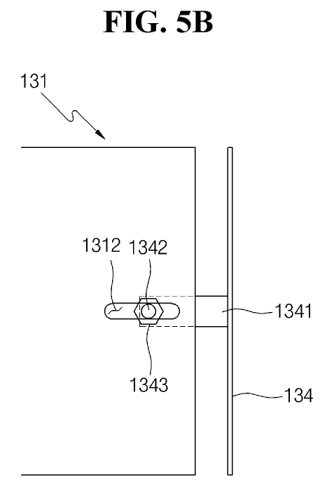

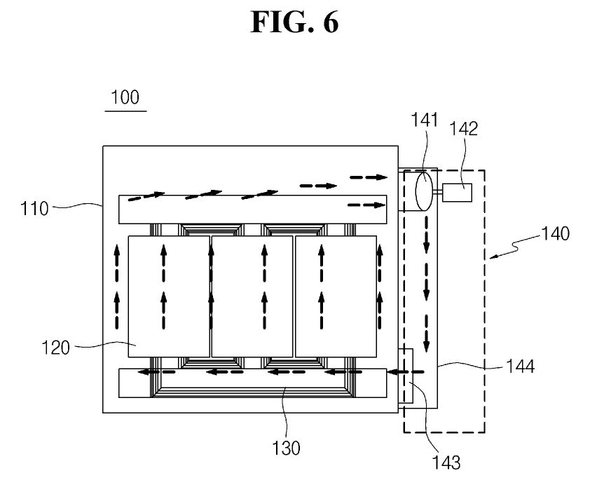

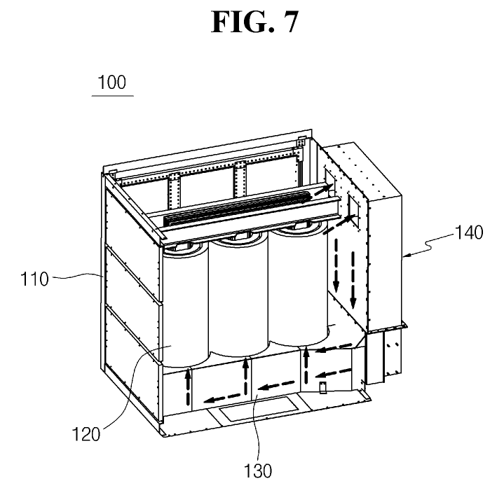

FIG. 1 is a perspective view illustrating a mold transformer for a shaft generator of a vessel according to an embodiment of the present disclosure, FIG. 2 is an image illustrating main components of the mold transformer for the shaft generator of the vessel according to an embodiment of the present disclosure, and FIG. 3 is a perspective view illustrating a duct-type air guide according to an embodiment of the present disclosure. FIGS. 4A and 4B are configuration diagrams illustrating a component for a distance adjustment function of an end plate of the duct-type air guide according to an embodiment of the present disclosure, FIGS. 5A and 5B are enlarged views illustrating the component for the distance adjustment function of the end plate of the duct-type air guide according to an embodiment of the present disclosure, and FIG. 6 is a side image illustrating a path through which cooling air flows in the mold transformer for the shaft generator of the vessel according to an embodiment of the present disclosure. FIG. 7 is an image illustrating the path through which cooling air flows in the mold transformer for the shaft generator of the vessel according to an embodiment of the present disclosure.

Referring to FIG. 1 to 7, a mold transformer 100 for a shaft generator of a vessel according to an embodiment of the present disclosure may include: an enclosure 110 forming a predetermined space therein; at least one winding portion 120 mounted inside the enclosure 110; a duct-type air guide 130 mounted on a lower portion of the enclosure 110 and configured to guide external cooling air to the winding portion 120; and a cooling air supply portion 140 configured to supply cooling air to the duct-type air guide 130.

The enclosure 110 forms an outer shape of the mold transformer 100 and supports a plurality of structures inside the enclosure 110. The enclosure 110 has a sealed space accommodating an iron core portion 122 and the winding portion 120 therein. The enclosure 110 is configured such that the duct-type air guide 130 that is a component for cooling is capable of being coupled to the lower portion of the enclosure 110, and the enclosure 110 performs a function of protecting internal components from an external environment while stably maintaining a flow of cooling air.

The winding portion 120 has a winding structure surrounding the iron core portion 122, and is required to be cooled so that heat generated by current applied from outside is rapidly dissipated. In the present disclosure, in order to increase cooling efficiency of the winding portion 120, the duct-type air guide 130 is applied as a structure that guides air to directly pass through the winding portion 120.

The duct-type air guide 130 has a structure assembled to a lower surface of the enclosure 110. Furthermore, as illustrated in FIG. 3, the duct-type air guide 130 includes a duct-shaped main body 131 having an open lower portion. The main body 131 has a fabricated-type structure formed of a plurality of plate members 1311. Accordingly, the main body 131 may be flexibly assembled so as to be applicable to a size or a structure of the mold transformer 100 that is variously designed according to an installation environment in the vessel, and maintenance of the main body 131 is also facilitated. Here, as an assembling method of the duct-type air guide 130, various methods may be applied, such as bolt fastening, rubber clip coupling, or sliding coupling between the plurality of plate members 1311, and such assembling methods may be variously modified according to an installation environment or a manufacturing process. The main body 131 has a duct shape having a width narrower than that of the enclosure 110, thereby guiding air introduced from outside to flow at a concentrated flow velocity within the duct shape.

A suction port 132 for receiving external cooling air is formed in a first end of the main body 131. As illustrated in FIG. 3, the suction port 132 has a flared shape in which a cross-sectional area increases toward an outside thereof. Accordingly, the suction port 132 may receive a larger amount of air efficiently. In addition, a plurality of winding portion cooling holes 133 is formed in an upper portion of the main body 131, so that air flowing along the duct is dispersed and flows toward the winding portion 120.

Conventionally, machining of a plurality of holes has been required to avoid interference with a winding shape or an arrangement of internal lead wires, so that air leakage frequently occurs. However, in the present disclosure, as described above, the main body 131 has the fabricated-type structure and the duct-type structure, and only a minimum opening required for the winding portion 120 is formed so as to implement a substantially sealed air guide, thereby being capable of minimizing air leakage and maximizing cooling efficiency of the winding portion 120.

An end plate 134 may be mounted on a second end of the main body 131. The end plate 134 performs a function of adjusting an internal air flow and sealing of a flow path. As illustrated in FIGS. 4A and 5B, the end plate 134 is configured such that a distance between the end plate 134 and the main body 131 is capable of being adjusted. For this purpose, a fixing clip 1341 is formed on the end plate 134 such that the fixing clip 1341 extends by a predetermined length in a direction in which the fixing clip 1341 is coupled to the main body 131, and a slot hole 1312 is formed in a side surface of the main body 131 at a position corresponding to the fixing clip 1341 in a longitudinal direction.

In order to clearly check such a configuration, the plate member 1311 in which the slot hole 1312 is formed is illustrated in FIG. 4A, and a state in which the corresponding plate member 1311 is removed and the fixing clip 1341 is exposed is illustrated in FIG. 4B.

The fixing clip 1341 includes a threaded portion 1342, and the threaded portion 1342 may pass through the slot hole 1312 and may be fastened to a nut 1343. By using this structure, the end plate 134 is capable of being moved in left and right directions along a longitudinal direction of the slot hole 1312, and a user may finely control pressure of an internal flow path and an air flow by adjusting the distance between the end plate 134 and the main body 131 to a desired distance.

For example, as illustrated in FIG. 5A, in a state in which the end plate 134 is in close contact with the main body 131, the position of the end plate 134 is capable of being fixed by fastening the nut 1343 to the threaded portion 1342 of the fixing clip 1341. In this case, pressure of cooling air flowing in the duct-type air guide 130 increases, and a flow velocity increases.

In addition, as illustrated in FIG. 5B, in a state in which the end plate 134 is spaced apart from the main body 131 by a predetermined distance, the position of the end plate 134 is capable of being fixed by fastening the nut 1343 to the threaded portion 1342 of the fixing clip 1341. In this case, pressure of cooling air flowing in the duct-type air guide 130 decreases, and a flow velocity decreases. The distance between the end plate 134 and the main body 131 may be changed and applied according to pressure and a flow velocity of air determined by an installation environment or a capacity of the mold transformer 100.

Meanwhile, the cooling air supply portion 140 is disposed outside the enclosure 110, and may include a fan 141, a motor 142 configured to drive the fan 141, a heat exchanger 143, and a cooler enclosure 144 accommodating the fan 141, the motor 142, and the heat exchanger 143.

Arrows illustrated in FIGS. 6 and 7 indicate a path through which cooling air flows in the mold transformer 100. Referring to FIGS. 6 and 7, external air drawn in through the cooling air supply portion 140 is cooled while passing through the heat exchanger 143. The cooled air flows into the main body 131 through the suction port 132 of the duct-type air guide 130 and then is dispersed to flow toward the winding portion 120 through the winding portion cooling holes 133. In addition, the cooling air having an increased temperature while cooling the winding portion 120 moves upward, is delivered to the heat exchanger 143 by the fan 141, and then is cooled again. Through supply and circulation of the cooling air, a temperature rise around the winding portion 120 is suppressed, and thermal stability of the entire mold transformer 100 is secured.

Here, the cooling air supply portion 140 may be configured as an Air Forced Water Forced (AFWF) type cooling cooler. The AFWF cooling cooler has a structure in which external air is forcibly introduced by the fan 141 and then the external air is cooled through heat exchange with cooling water in the heat exchanger 143 mounted therein. This method has an advantage of securing high cooling efficiency in a marine environment and is capable of stably supplying air at a lower temperature compared to a system that performs cooling using only external air. The cooled air is guided to the winding portion 120 through the duct-type air guide 130 to perform effective cooling.

According to the embodiments of the present disclosure described above, the duct-type air guide and the mold transformer for the shaft generator of the vessel including the same have the following effects. As the duct-type air guide is mounted on the lower portion of the enclosure and effectively guides external cooling air to the winding portion, thereby significantly increasing cooling efficiency. Furthermore, by guiding air to directly pass through the winding portion, an air flow velocity may be increased, and a temperature rise of a winding may be suppressed.

In addition, since the main body is formed of the plurality of plate members such that the main body is capable of being assembled, the manufacturing process is simplified, and flexible countermeasure according to an installation space is capable of being realized. Accordingly, manufacturability and maintainability of the mold transformer may be increased, and work efficiency in an actual vessel environment may also be increased.

In addition, through the structure in which the position of the end plate is capable of being adjusted, a flow of cooling air and internal pressure may be finely controlled, so that uniform cooling of each winding portion is capable of being realized. As a result, thermal reliability and lifespan of the entire transformer are increased.

Furthermore, by reducing unnecessary hole machining, the design is simplified and air leakage is minimized, thereby achieving increased results in terms of energy efficiency. This may lead to energy savings and operating cost reduction of vessel power equipment.

Although the present disclosure has been described above with reference to embodiments thereof, those of skill in the art will appreciate that various modifications and changes may be made to the present disclosure without departing from the spirit and scope of the disclosure as set forth in the claims below. Therefore, if a modified implementation basically includes components of the claims of the present disclosure, it should be considered to be included in the scope of the present disclosure.

1. A duct-type air guide for guiding cooling air to a winding portion of a mold transformer for a shaft generator of a vessel, the duct-type air guide comprising:
a duct-shaped main body having an open lower portion;
a suction port formed in a first end of the main body and configured to introduce external cooling air thereinto; and
a winding portion cooling hole formed in an upper portion of the main body and configured to guide the cooling air to the winding portion of the mold transformer,
wherein the main body is formed of a plurality of divided plate members such that the main body is capable of being assembled.

2. The duct-type air guide of claim 1, wherein the main body is assembled to a lower surface of an enclosure of the mold transformer and forms a duct having a width narrower than that of the enclosure, thereby forming a passage through which the cooling air flows.

3. The duct-type air guide of claim 1, wherein the suction port has a cross-sectional area that increases toward an outside thereof.

4. The duct-type air guide of claim 1, further comprising:
an end plate mounted on a second end of the main body and configured to adjust an air flow and sealing of an internal flow path,
wherein the end plate is configured such that an assembly distance between the end plate and the main body is capable of being adjusted.

5. The duct-type air guide of claim 4, further comprising:
a fixing clip formed on the end plate such that the fixing clip extends toward the main body; and
a slot hole provided in a side wall of the main body and formed in a position corresponding to the fixing clip such that the slot hole extends for a predetermined length,
wherein the fixing clip is fastened and fixed at a desired position of the slot hole, thereby adjusting the assembly distance between the end plate and the main body.

6. The duct-type air guide of claim 5, wherein the fixing clip is fixed at the desired position by fastening a nut to a threaded portion which extends from a first side of the fixing clip and which passes through the slot hole.

7. A mold transformer for a shaft generator of a vessel, the mold transformer comprising:
an enclosure forming a predetermined space therein;
at least one winding portion mounted inside the enclosure; and
a duct-type air guide mounted on a lower portion of the enclosure and configured to guide external cooling air to the winding portion,
wherein the duct-type air guide is assembled to a lower surface of the enclosure and forms a duct having a width narrower than that of the enclosure, thereby forming a passage through which the cooling air flows.

8. The mold transformer of claim 7, wherein the duct-type air guide comprises:
a duct-shaped main body having an open lower portion;
a suction port formed in a first end of the main body and configured to introduce external cooling air thereinto; and
a winding portion cooling hole formed in an upper portion of the main body and configured to guide the cooling air to the winding portion of the mold transformer.

9. The mold transformer of claim 8, wherein the main body is formed of a plurality of divided plate members such that the main body is capable of being assembled.

10. The mold transformer of claim 8, wherein the suction port has a cross-sectional area that increases toward an outside thereof.

11. The mold transformer of claim 8, wherein the duct-type air guide further comprises:
an end plate mounted on a second end of the main body and configured to adjust an air flow and sealing of an internal flow path, and
wherein the end plate is configured such that an assembly distance between the end plate and the main body is capable of being adjusted.

12. The mold transformer of claim 7, further comprising:
a cooling air supply portion provided on a first side of the enclosure and configured to supply the cooling air to the duct-type air guide.
